(19) United States
(12) Patent Application Publication
(10) Pub. No.: US 2018/0115894 A1
(43) Pub. Date: Apr. 26, 2018

(54) USER IDENTIFICATION BASED ON A PERSONAL IDENTIFICATION PICTURE

(71) Applicant: INTERNATIONAL BUSINESS MACHINES CORPORATION, Armonk, NY (US)

(72) Inventors: MARK E. MARESH, WAKE FOREST, NC (US); COLM NOLAN, MEATH (IE); JUAN F. VARGAS, CARY, NC (US); MICHAEL J. WHITNEY, CARY, NC (US)

(21) Appl. No.: 15/332,102

(22) Filed: Oct. 24, 2016

(51) Int. Cl. H04W 12/06; H04M 1/725; H04L 29/06; H04W 12/08; G06F 3/0482

(52) U.S. Cl. CPC H04W 12/06; H04M 1/72519; H04L 63/10; H04M 2203/6018; H04L 63/08; G06F 3/0482; H04W 12/08

(57) ABSTRACT

A computer-implemented method for securing access to a host site. The method includes creating, using a processor system, an access code for access to a user account hosted by the host site and providing, using the processor system, the access code to the host site, the access code including user provided images in a defined sequence. The method also includes creating, using the processor system, an access attempt code for access to the user account hosted by the host site and transmitting, by the processor system, the access attempt code to the host site. Based on a determination that the access attempt code matches the access code, the method includes accessing, using the processor system, the user account hosted by the host site.

### BACKGROUND

Individuals utilize websites for multiple reasons. For certain transactions, such as financial transactions, secured access to the host site is desired to prevent unauthorized access. A security system is desired to prevent unauthorized access.

### SUMMARY

In accordance with one embodiment, a computer-implemented method for securing access to a host site is provided. The method includes creating, using a processor system, an access code for access to a user account hosted by the host site and providing, using the processor system, the access code to the host site, the access code including user provided images in a defined sequence. The method also includes creating, using the processor system, an access attempt code for access to the user account hosted by the host site and transmitting, by the processor system, the access attempt code to the host site. Based on a determination that the access attempt code matches the access code, the method includes accessing, using the processor system, the user account hosted by the host site.

In accordance with one embodiment, a system for securing access to a host site is provided. The system includes a user device having a display, a camera, a processor system, and a memory all in electrical communication. A plurality of images, some of which may be captured by the camera of the user device are stored in the memory and used to define an access code, which is defined by a user by selecting a group of images from the plurality of images in a sequence and associating respective access codes access rights to the host site. A rendering system alters the images contained within the access code and a transmitter transmits the rendered access code to a host site.

In accordance with one embodiment, a computer program product for securing access to a host site is provided. The computer program product includes a computer-readable storage medium having program instructions embodied therewith, wherein the computer readable storage medium is not a transitory signal per se, and the program instructions readable by a processing circuit to cause the processing circuit to perform a method. The method includes creating, using a processor system, an access code for access to a user account hosted by the host site and providing, using the processor system, the access code to the host site, the access code including user provided images in a defined sequence. The method also includes creating, using the processor system, an access attempt code for access to the user account hosted by the host site and transmitting, by the processor system, the access attempt code to the host site. Based on a determination that the access attempt code matches the access code, the method includes accessing, using the processor system, the user account hosted by the host site.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 illustrates a general overview of a system for securing access to a host site according to one embodiment;

FIG. 2 illustrates a device for originating access codes for securing access to a host site according to one embodiment;

FIG. 3 illustrates a flow chart of a system for originating access codes for securing access to a host site according to one embodiment;

FIG. 4 illustrates the development of access codes for securing access to a host site according to one embodiment;

FIG. 5 illustrates a flow chart of a system for determining access to a host site according to one embodiment; and

FIG. 6 shows a computer system according to an embodiment.

### DETAILED DESCRIPTION

Embodiments of the present disclosure include systems, computer program products, and methods for securing access to a host site. In exemplary embodiments, user-defined access codes are generated by a user and are provided to a host site for retention. Subsequent attempts to access information from the host site require the user to submit access attempt codes which must match the previously submitted and retained access codes. In exemplary embodiments, the access code is generated utilizing multiple images captured by the user and assembled into a user defined sequence. Once assembled, the images are rendered creating rendered images that become access codes. In exemplary embodiments, rendering the images includes performing processing on the images to obscure the image as it is provided to the remote host site.

In exemplary embodiments, the access codes are assigned access rights defining what access a user submitting the respective access code is granted by the host site. In one embodiment, a plurality of access codes having different access rights are submitted to a host site for storage. Access to the host site is controlled by the submission of an access attempt code and the comparison of the code with a previously submitted access code which is utilized as a reference.

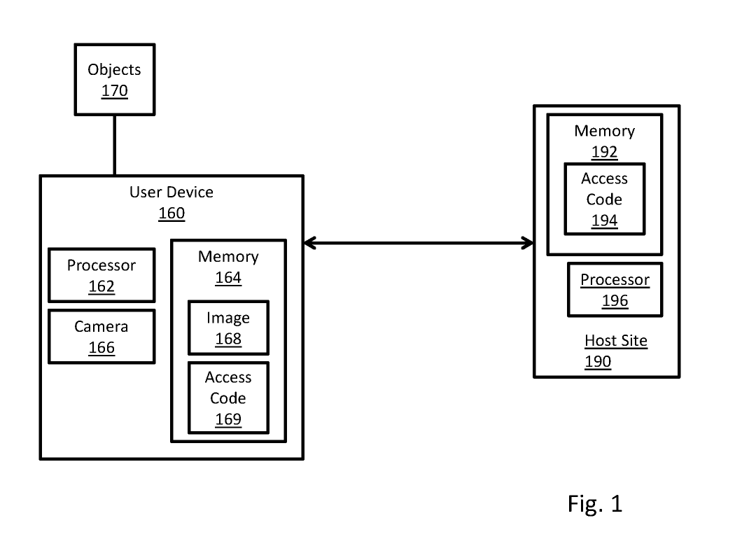

Referring now to FIG. 1, a user device 160 for creating and submitting access codes for accessing information on a remote host site 190 is shown. The user device 160 may be any type of computing device capable of communicating with remote host site 190 via a network. For example, the user device 160 can be a desktop computer, a laptop mobile computer, a personal data assistant, or a smartphone. The user device 160 includes a memory 164 and a processor 162 for controlling the operation of user device 160. In an embodiment, user device 160 is a mobile device such as a smartphone and the respective memories and processors run an application for creating and submitting access codes 169. The remote host site 190 can be any site requiring a password or other security feature for access. The remote host site 190 includes accessible features, a processor 196 and associated memory 192 which stores access codes 194 provided by a user utilized in providing access to the remote host site. In one particular embodiment, remote host site 190 may be a financial institution such as a bank and the accessible features include checking balances, transferring funds, depositing money, or paying bills. In exemplary embodiments, the features of the host site can also include access to specific types of content. The user device 160 includes a camera 166 for capturing pictures of objects 170. The images 168 of objects 170 are stored in memory 164 for utilization in creating access codes 169. The display, camera, processor system, and memory all in electrical communication.

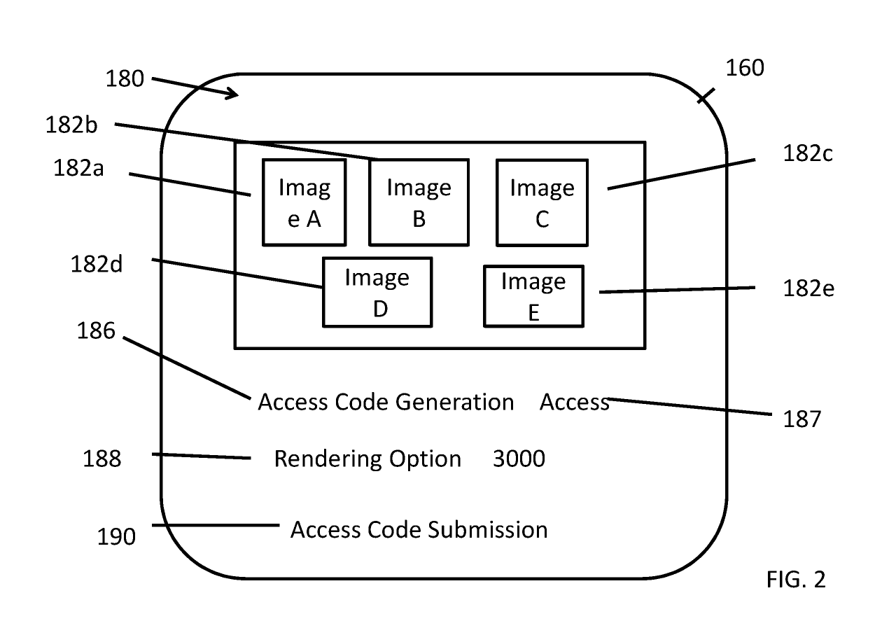

As shown in FIG. 2, device 160 includes a display 180 for displaying information to the user. Display 180 may display a plurality of images utilized for the creation of an access code. As shown in FIG. 2, Image A 182a, Image B 182b, Image C 182d, Image D 182d and Image E 182 are provided for the creation of a respective access code. Device 160 is utilized in the generation of access codes and also in the submission of access codes for accessing remote host site 190. As shown in FIG. 2, access code generation input key 186 enables the user to engage the processor in generating an access code by selecting the respective images in a particular sequence. With the access code defined, access input key 187 enables the user to assign access rights to the respective access code. In certain embodiments, an additional security level includes rendering each image when it is assigned as part of an access code. Rendering option key 188 provides the user with multiple rendering options provided by the application for rendering the image. The various renderings obscure the image as it is provided to the remote host site. The rendering provides for security and anonymity. As shown in FIG. 2, rendering option 3000 is utilized. This option may pixelate the images in a particular random order. Additional rendering options are also provided. When creating or submitting access codes, the images may be displayed as a gallery all at one time with the sequence being established by touching the respective images if display 180 is a touch screen.

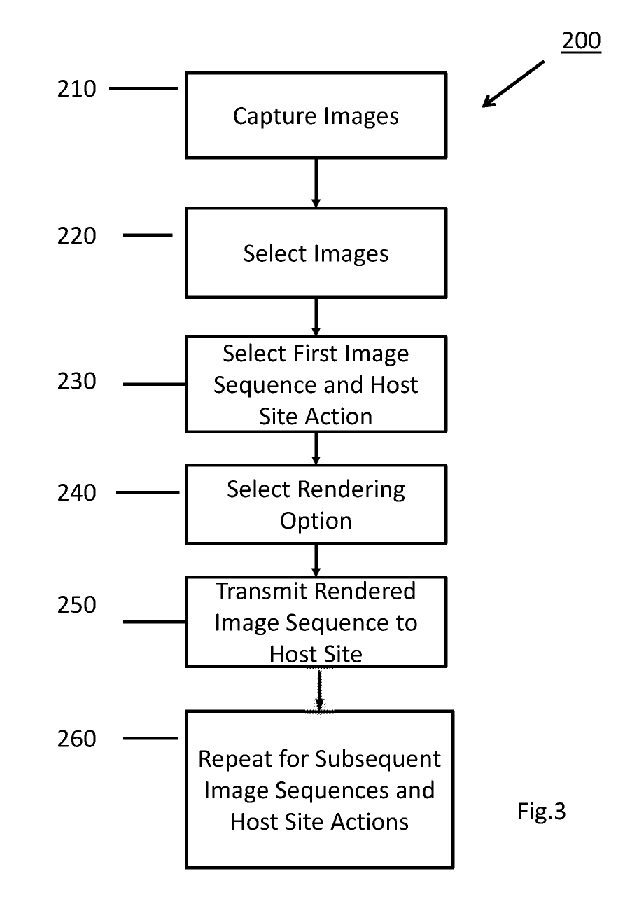

According to one embodiment, as shown in FIG. 3, a user may engage in a method 200 of creating an access code for a remote host site. Initially, images are captured by the user at block 210. In one embodiment, the images are captured using a camera and are unique to the user and the user device. The user may upload the images to a remote user device such as a home computer providing access to a remote site for both the user device and remote user device. In another embodiment, the images can be individually selected by an individual from other external sources such as websites. The images are stored in the memory of the user device. After images are captured, the user selects individual images for creating a unique access code, as shown at block 220. Next, as shown at block 230, the selected images are arranged by the user to define the access code. Once defined, the user assigns the appropriate access rights associated for that particular access code. This defines the access which the host site will provide to the user when provided with the respective access code. Next, as shown at block 240, the user selects a rendering option for rendering the selected images in the access code. At block 250, the access code of rendered images is transmitted to the host site with the associated access rights. The rendered access code will be stored by a storage associated with the remote host site and subsequently utilized for determining if a remote request to access the remote host site is authorized or denied. At block 260, the process of creating additional access codes is conducted enabling the user to create different levels of secured access to the respective accounts associated with the remote host site. In this manner, varying degrees of access can be granted depending on the access codes presented by the user. For example, the host site may provide access to a user account to withdraw funds and the host site may limit an amount of funds available for withdrawal based upon authorized access associated with the access attempt code.

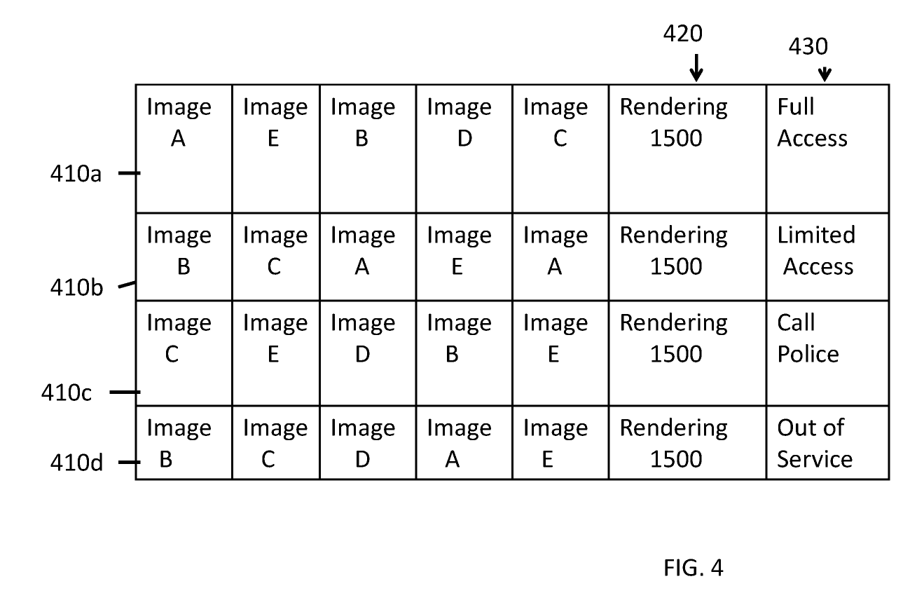

FIG. 4 illustrates a plurality of access codes created by a user. Access code 410a includes five images in the specific sequence of Image A, Image E, Image B Image D, and Image C. The specific access code with the respective images in the designated sequence was rendered utilizing rendering option 420 fifteen hundred. When created, access code 410a was authorized to have an access parameter 430 of full access to the associated user account hosted by the host site. Access code 410b includes five images in the specific sequence of Image B, Image C, Image A, Image E, and Image A. The specific access code with the respective images in the designated sequence was rendered using rendering option fifteen hundred. Other rendering options would be available. When created, access code 410b was authorized to have limited access to the associated user account hosted by the host site. In the situation when the host site is a bank, limited access may include only providing a balance, only authorizing the withdrawal of a limited amount, only authorizing deposits or other limiting feature. Access code 410c includes five images in the specific sequence of Image C, Image E, Image D, Image B, and Image E. This specific access code was rendered using rendering option fifteen hundred. When created, access code 410c is established to function as a panic feature initiating a distress phone call to the police or other emergency assistance provider. In this embodiment, the user device is a mobile phone apparatus capable of initiating a phone call and the phone call is initiated based upon the entry of access code 410c. As illustrated, a special code may be generated to return a special message. Access code 410d includes five images in the specific sequence of Image B, Image C, Image D, Image A, and Image E rendered using rendering option fifteen hundred. When utilized, a message stating “Out of Service” may be supplied to the display of the user device.

In operation, once the respective access codes are generated by the user device and rendered utilizing a rendering option selected by the user, the access codes are provided to the remote host site. The access codes with their designated functional access authorization are associated with the user's account by the host site and determined if appropriate access should be provided.

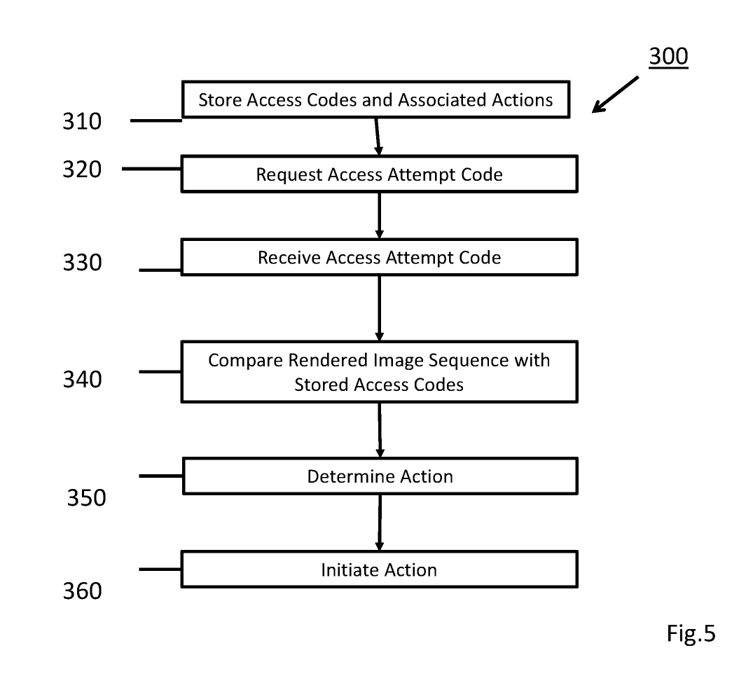

As shown in FIG. 5, the remote host site provides a host site security operation method 300 to restrict access to the user's account. The remote host site receives the unique access codes utilizing user provided images in a rendered format as shown in FIG. 4 and stores them in association with the user's account at block 310. A user device may attempt to access the user account utilizing host site access input key, such as the one shown in FIG. 2. When initially contacted by the user, the host site synchronizes a connection with the user. This initial connection may utilize an initial sign on identification parameter such as a user identification or the user device may have a token which it submits to the host site for initially accessing the site and identifying the user. Once the user device is in communication with the host site, the host site requests the user to provide an access attempt code at block 320. The request from the host directs the application program to request that the user input a specific access attempt code. The access attempt code includes the user selecting the images originating in the memory of the user device in a predetermined sequence and select a rendering request rendering the images creating an access attempt code. The images can be displayed by the display of the user device. This access attempt code is transmitted to the remote host site.

At block 330, the remote host site receives the rendered images and their sequence, which originate from the user which constitute an access attempt code. At block 340, the submitted rendered images and sequence are compared with the previously submitted access codes which have been stored in a manner accessible by the host site. For example, if the user submitted five images in the specific sequence of Image A, Image E, Image B Image D, and Image C rendered in the manner as provided by selecting rendering option 150, then at block 350, after the submitted access attempt code is compared with the stored access codes, the host site would determine that an appropriate access code corresponding to access code 410a illustrated in FIG. 3 has been provided by the user. Based upon the submitted access code 410a, the host site would make the determination and identify the appropriate action based on that specific code. At block 360, if from the example, the submitted access attempt code matches the access code for access code 410a, the access authorized by the respective access code will be granted. If the submitted access attempt code does not match any previously provided access code, access will be denied. Additionally, if the submitted requests matched the emergency call or return message, those steps would be undertaken.

An advantage of the system involves the provision of images from the user's own gallery of available images. The images may be personal such as a child or from a particular natural setting, or random such as a stock photo taken from another source. However, each photo is available to the user to select in any desired sequence and then rendered using any available means provided by the application. The user is able to customize access codes which can only be created by the gallery of images available only to the user. Additionally, by rendering the images in a manner which makes the images visually unrecognizable, the content of the images is protected and cannot be reproduced in the event of a data breach.

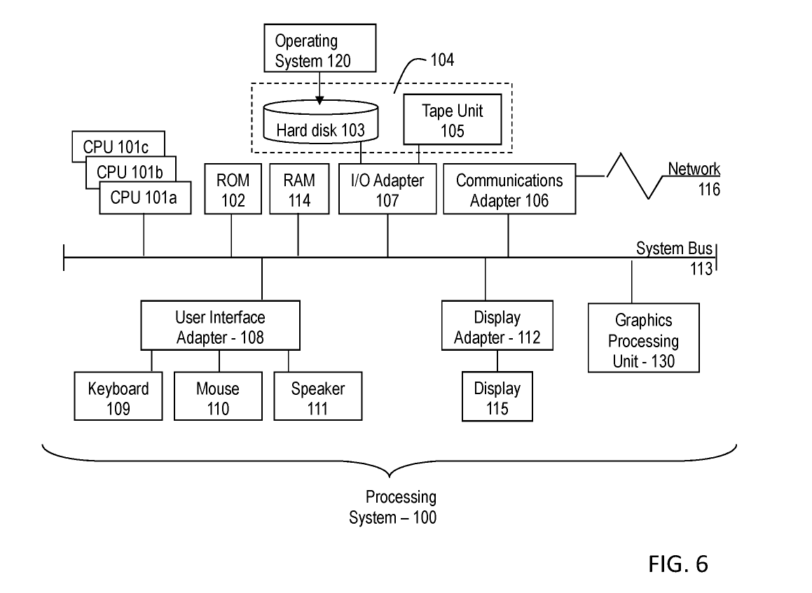

Referring to FIG. 6, there is shown primary computer system 100 according to one or more embodiments. First computing device 160 may have the same configuration as primary computer system 100. The primary computer system 100 has one or more central processing units (processors) 101a, 101b, 101c, etc. (collectively or generically referred to as processor(s) 101). In one or more embodiments, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 6 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling log management system 100 to communicate with other such systems. A screen (e.g., a display monitor) 115 is connected to system bus 113 by display adaptor 112, which may include a graphics adapter to improve the performance of graphics intensive applications and a video controller. In one or more embodiments, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

Thus, as configured in FIG. 6, the processing system 100 includes processing capability in the form of processors 101, storage capability including the system memory 114 and mass storage 104, input means such as keyboard 109 and mouse 110, and output capability including speaker 111 and display 115. In one or more embodiments, a portion of system memory 114 and mass storage 104 collectively store an operating system to coordinate the functions of the various components.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically identified device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, micro-identifier, firmware instructions, state-setting data, or either source identifier or object identifier written in any combination of one or more programming languages, including an object-oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), a wireless LAN (WLAN using WiFi), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer-implemented method for securing access to a host site, the method comprising:
creating, using a processor system, an access code for access to a user account hosted by the host site;
providing, using the processor system, the access code to the host site, the access code comprising user provided images in a defined sequence, wherein the user provided images are rendered to obscure the user provided images to be visually unrecognizable;
creating, using the processor system, an access attempt code for access to the user account hosted by the host site;
transmitting, by the processor system, the access attempt code to the host site; and
based on a determination that the access attempt code matches the access code, accessing, using the processor system, the user account hosted by the host site.

2. The computer-implemented method of claim 1, wherein a user device transmits the access attempt code, and wherein the user device is a mobile apparatus comprising a processor and a memory in data communication with the processor, and wherein the memory stores at least one application computer program configured for controlling the processor for submitting the access attempt code.

3. The computer-implemented method of claim 2, wherein the user device includes a camera, wherein the memory contains images captured by the camera, and wherein the images are utilized by a user to define the access code to the user account hosted by the host site.

4. The computer-implemented method of claim 3, wherein the user selects a group of images stored in the memory in a definitive sequence to define the access code, the access code submitted by the user to the host site for storage by the host site for determining access to the host site by access attempt codes.

5. The computer-implemented method of claim 4, wherein the access code permits access to certain features of the user account hosted by the host site.

6. The computer-implemented method of claim 5, wherein the user defines a plurality of access codes each associated with a different grouping of images stored in memory, each access code providing different access to features of the user account hosted by the host site.

7. The computer-implemented method of claim 4, wherein the user selects a rendering profile for modifying the selected group of images prior to submission to the host site for creating an access code, wherein the rendering profile indicates a manner of obscuring the selected group of images.

8. The computer-implemented method of claim 4, wherein the mobile apparatus includes a display, the application computer program querying a user via the display to select the group of images for defining an access code and associate access rights to the access code.

9. The computer-implemented method of claim 4, wherein the mobile apparatus is capable of initiating a phone call, wherein a phone call is initiated based upon the access code submitted by the user.

10. A system for securing access to a host site, the system comprising:
a user device having a display, a camera, a processor system, and a memory, wherein the display, camera and processor system are in electrical communication;
a plurality of images, at least some of the images captured by the camera and stored in the memory;
an access code defined by a user by selecting a group of images from the plurality of images in a sequence and associating respective access codes access rights to the host site;
a rendering system configured to alter the images contained within the access code, wherein the images contained within the access code are altered to be visually unrecognizable; and
a transmitter for transmitting the rendered access code to a host site.

11. The system of claim 10, further including a host site including a user account with accessible features and associated memory, the access code with access rights being transmitted to the host site associated memory for storage and subsequent utilization in authorizing requests for accessing the accessible features.

12. The system of claim 11, wherein the device is a mobile apparatus comprising a processor and a memory in data communication with the processor, and wherein the memory stores at least one application computer program configured for controlling the processor for submitting the access codes to the host site.

13. The system of claim 12, wherein the user selects a group of images stored in the memory in a definitive sequence to define the access code, the access code submitted by the user to the host site for storage by the host site for determining access to the host site by subsequent access request codes.

14. The system of claim 13, wherein the user defines a plurality of access codes each associated with a different grouping of images stored in the memory, each access code providing different access to features of the user account hosted by the host site.

15. The system of claim 13, wherein the user selects a rendering profile for modifying the selected group of images prior to submission to the host site, wherein the rendering profile indicates a manner of obscuring the selected group of images.

16. The system of claim 12, wherein the mobile apparatus includes a display, the application computer program querying a user via the display to select the group of images for defining an access code and associate access rights to the access code.

17. A computer program product for securing access to a host site, the computer program product comprising a computer readable storage medium having program instructions embodied therewith, wherein the computer readable storage medium is not a transitory signal per se, the program instructions readable by a processing circuit to cause the processing circuit to perform a method comprising:
creating, using a processor system, an access code for access to a user account hosted by the host site;
providing, using the processor system, the access code to the host site, the access code comprising user provided images in a defined sequence, wherein the user provided images are rendered to obscure the user provided images to be visually unrecognizable;
creating, using the processor system, an access attempt code for access to the user account hosted by the host site;
transmitting, by the processor system, the access attempt code to the host site; and
based on a determination that the access attempt code matches the access code, accessing, using the processor system, the user account hosted by the host site.

18. The computer program product of claim 17, including a user device and wherein the user device is a mobile apparatus comprising a processor and a memory in data communication with the processor, and wherein the memory stores at least one application computer program configured for controlling the processor and further including a camera, wherein the memory contains images captured by the camera, and wherein the images are utilized by a user to define the access code to the user account hosted by the host site.

19. The computer program product of claim 18, wherein the user selects a group of images stored in the memory in a definitive sequence to define the access code, the access code submitted by the user to the host site for storage by the host site for determining access to the host site by subsequent access request codes.

20. The computer program product of claim 18, wherein the user defines a plurality of access codes each associated with a different grouping of images stored in memory, each access code providing different access to features of the user account hosted by the host site.
